(19) United States
(12) Patent Application Publication
(10) Pub. No.: US 2025/0190040 A1
(43) Pub. Date: Jun. 12, 2025

(54) ELECTRONIC APPARATUS AND CONTROL METHOD

(71) Applicant: CANON KABUSHIKI KAISHA, Tokyo (JP)

(72) Inventor: HIROKI KITANOSAKO, Tokyo (JP)

(21) Appl. No.: 18/974,484

(22) Filed: Dec. 9, 2024

(30) Foreign Application Priority Data
Dec. 12, 2023 (JP) 2023-209546

(51) Int. Cl. G06F 1/26; H02J 1/08

(52) U.S. Cl. CPC G06F 1/26; H02J 1/084

(57) ABSTRACT

An electronic apparatus includes a communication unit that communicates with a first power supply apparatus, and communicates with a second power supply apparatus, a power reception unit that receives power supplied from the first power supply apparatus via a first port and receives power supplied from the second power supply apparatus via a second port; and a control unit that performs control to, when the power reception unit receives power from the first power supply apparatus connected to the first port and does not receive power from the second power supply apparatus connected to the second port, stop power reception from the first power supply apparatus and start power reception from the second power supply apparatus in response to an instruction for selecting the second port received from a user.

### BACKGROUND

### Field of the Disclosure

The present disclosure relates to an electronic apparatus that can receive power from a plurality of power supply apparatuses.

### Description of the Related Art

The universal serial bus (USB) power delivery (PD) standard is a standard that can supply power by connecting a power supply apparatus and a power receiving apparatus by a connector and a cable of the USB Type-C standard. In the USB PD standard, a power supply apparatus (source) and a power receiving apparatus (sink) perform communication for deciding power that can be supplied or can be received based on a power rule including a combination of a voltage value and a current value.

Furthermore, in the USB PD standard, which one of the apparatuses connected by the USB Type-C cable to set as the power supply apparatus and the power receiving apparatus can be determined (Japanese Patent Laid-Open No. 2018-7450). Furthermore, in the USB PD standard, extended functions other than USB communication, such as analog audio signal communication and data communication of other standards, can be used.

As described above, since various functions are added and extended in the USB PD standard, it is assumed that a plurality of power supply apparatuses can be connected to the power receiving apparatus by the USB Type-C cable in the future.

However, in the prior art, the control is limited to the control of power reception or power supply between the apparatuses connected by the single USB Type-C cable, and the control to select a power supply apparatus from which the power receiving apparatus receives power when a plurality of power supply apparatuses are connected to the power receiving apparatus.

### SUMMARY

The present disclosure has been made in consideration of the aforementioned problems, and realizes a technology (realizes techniques) that can select a power supply apparatus from which power is received from a plurality of power supply apparatuses connected to a power receiving apparatus.

In order to solve the aforementioned problems, the present disclosure provides an electronic apparatus comprising: a first power reception port; a second power reception port; and at least one circuit or processor that causes the electronic apparatus to function as: a communication unit that, when a first power supply apparatus is connected to the first power reception port, communicates with the first power supply apparatus, and when a second power supply apparatus is connected to the second power reception port, communicates with the second power supply apparatus; a power reception unit that receives power supplied from the first power supply apparatus via the first power reception port and receives power supplied from the second power supply apparatus via the second power reception port; and a control unit that performs control to, when the power reception unit receives power from the first power supply apparatus connected to the first power reception port and does not receive power from the second power supply apparatus connected to the second power reception port, stop power reception from the first power supply apparatus connected to the first power reception port and start power reception from the second power supply apparatus connected to the second power reception port in response to receiving an instruction from a user to select the second power reception port.

In order to solve the aforementioned problems, the present disclosure provides a control method of an electronic apparatus: wherein the electronic apparatus includes, a first power reception port, a second power reception port, a communication unit that, when a first power supply apparatus is connected to the first power reception port, communicates with the first power supply apparatus, and when a second power supply apparatus is connected to the second power reception port, communicates with the second power supply apparatus, and a power reception unit that receives power supplied from the first power supply apparatus via the first power reception port and receives power supplied from the second power supply apparatus via the second power reception port; and the control method includes: performing control to, when the power reception unit receives power from the first power supply apparatus connected to the first power reception port and does not receive power from the second power supply apparatus connected to the second power reception port, stop power reception from the first power supply apparatus connected to the first power reception port and start power reception from the second power supply apparatus connected to the second power reception port in response to receiving an instruction from a user to select the second power reception port.

According to the present disclosure, a power supply apparatus from which power is received can be selected from a plurality of power supply apparatuses connected to a power receiving apparatus.

Further features of the present disclosure will become apparent from the following description of exemplary embodiments (with reference to the attached drawings).

### BRIEF DESCRIPTION OF THE DRAWINGS

FIG. 1 is a diagram illustrating a system configuration according to one or more aspects of the present disclosure.

FIG. 2 is a block diagram illustrating a configuration of an electronic apparatus according to one or more aspects of the present disclosure.

FIG. 3 is a block diagram illustrating a configuration of a power supply apparatus according to one or more aspects of the present disclosure.

FIG. 4 is a block diagram illustrating a configuration of a power supplying/charging control unit of the electronic apparatus according to one or more aspects of the present disclosure.

FIG. 5 is a flowchart illustrating control processing of the electronic apparatus according to one or more aspects of the present disclosure.

FIGS. 6A to 6F are diagrams illustrating a display example of USER INTERFACE (UI) in the control processing according to one or more aspects of the present disclosure.

FIG. 7 is a diagram illustrating a display example of the UI in the control processing according to one or more aspects of the present disclosure.

FIG. 8 is a flowchart illustrating power reception port switching processing of the electronic apparatus according to one or more aspects of the present disclosure.

FIGS. 9A and 9B are diagrams illustrating a display example of a UI in the power reception port switching processing according to one or more aspects of the present disclosure.

FIGS. 10A to 10E are diagrams illustrating a display example of the UI in the power reception port switching processing according to one or more aspects of the present disclosure.

FIG. 11 is a flowchart illustrating control processing according to a remaining amount of a battery of the electronic apparatus according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### System Configuration

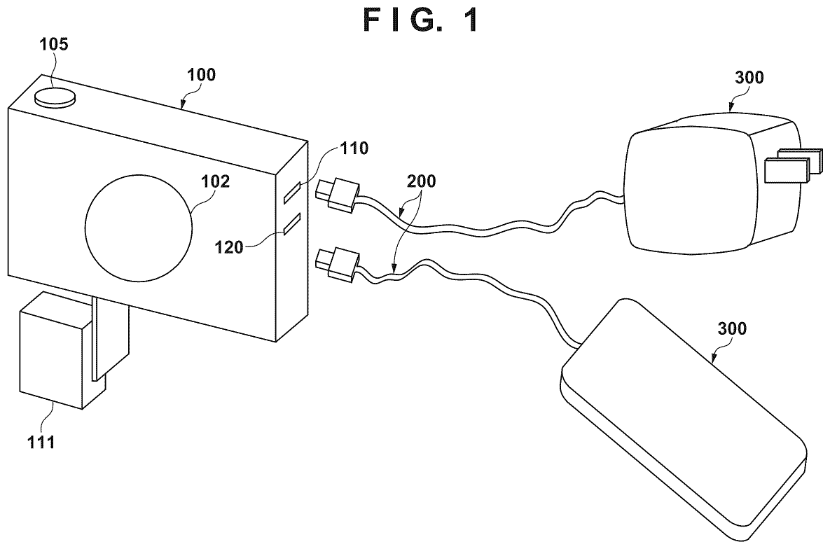

A system configuration of the present embodiment will be described with reference to FIG. 1.

The system of the present embodiment includes an electronic apparatus 100 and one or more power supply apparatuses 300 connectable to the electronic apparatus 100. In the electronic apparatus 100, one or a plurality of power supply apparatuses 300 can be connected by a connection cable 200.

The electronic apparatus 100 is an image capturing device such as a digital camera. The electronic apparatus 100 operates as a power receiving apparatus that can receive power from any of the power supply apparatuses 300 connected to the electronic apparatus 100. The electronic apparatus 100 is operable by power received from the power supply apparatus 300. The electronic apparatus 100 is not limited to the image capturing device, and may be an information processing device such as a personal computer (PC) or a portable multifunction terminal such as a tablet PC or a smartphone as long as it can receive power from any of a plurality of power supply apparatuses.

The power supply apparatus 300 is an external apparatus that can supply power to the electronic apparatus 100, and is a power source device such as a charger or a power source (AC-DC) adapter connectable to a commercial power source, or a power source device such as a power bank. Note that the power supply apparatus of the present embodiment is not limited to a charger, a power source adapter, and a mobile battery, and may be an information processing device such as a personal computer (PC) or a portable multifunction terminal such as a tablet PC or a smartphone that can supply power to the electronic apparatus 100.

The electronic apparatus 100 includes an imaging unit 102, an operation unit 105, a first connector 110, a second connector 120, and a battery 111.

The imaging unit 102 converts an optical image of a subject into an electrical signal to generate image data. The operation unit 105 includes an operation member that receives a user operation. The first connector 110 and the second connector 120 are connected to a connector to be described later of one or a plurality of power supply apparatuses 300 by a connection cable 200. The first connector 110 and the second connector 120 are a first connector and a second connector conforming to the USB Type-C standard. The connection cable 200 is a cable conforming to the USB Type-C standard.

The battery 111 supplies power for operating the electronic apparatus 100 when the battery 111 is attached to the electronic apparatus 100. The battery 111 is detachable and attachable with respect to the electronic apparatus 100, and the user can easily attach and detach the battery 111 to and from the electronic apparatus 100 by an attachment/discharge mechanism (not illustrated). The electronic apparatus 100 can be operated by the power of the battery 111 or the power supplied from the power supply apparatus 300. Furthermore, the electronic apparatus 100 can also charge the battery 111 with power supplied from the power supply apparatus 300.

In the present embodiment, the electronic apparatus 100 operates as a sink (USB device) conforming to a universal serial bus (USB) power delivery (PD) standard. In addition, the power supply apparatus 300 operates as a source (USB host) conforming to the USB PD standard. The electronic apparatus 100 and the power supply apparatus 300 perform power negotiation for deciding a supply power from a combination of a voltage value and a current value decided in advance based on a power rule. In this way, when the electronic apparatus 100, the power supply apparatus 300, and the connection cable 200 conform to the USB PD 3.1 standard, power of up to 240 W can be exchanged.

In addition, the power supply apparatus 300 is connected to the first connector 110 and the second connector 120 of the electronic apparatus 100 via the USB cable 200, respectively.

### Configuration of Electronic Apparatus 100

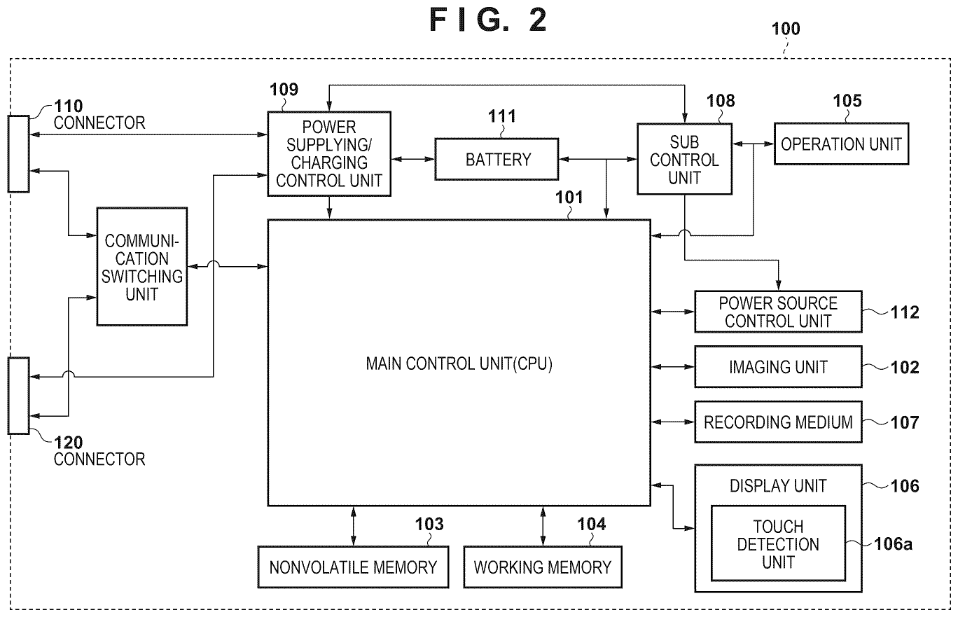

Next, a configuration and a function in a case where the electronic apparatus 100 of the present embodiment is a digital camera will be described with reference to FIG. 2.

A main control unit 101 is an arithmetic processing unit (CPU) that integrally controls the entire electronic apparatus 100, and realizes communication processing and control processing to be described later by executing a program stored in a nonvolatile memory 103 to be described later. Note that, instead of the main control unit 101 controlling the entire apparatus, the entire apparatus may be controlled by assigning processing to a plurality of pieces of hardware. In addition, the main control unit 101 may be configured as a microcontroller including a processor such as a CPU, a memory such as a ROM and a RAM, a controller, and a peripheral circuit.

The imaging unit 102 includes a lens group including a zoom lens or a focus lens, and a shutter having a diaphragm function. Furthermore, the imaging unit 102 includes an image sensor configured by a CCD, a CMOS element, or the like that converts a subject image into an electrical signal, and an A/D converter that converts an analog image signal output from the image sensor into a digital signal. Under the control of the main control unit 101, the imaging unit 102 converts a subject image light formed by the lens included in the imaging unit 102 into an electrical signal by the image sensor, performs noise reduction processing or the like, and outputs image data constituted by the digital signals.

The main control unit 101 performs resize processing such as pixel interpolation and reduction, as well as color conversion processing, on image data captured by the imaging unit 102. Furthermore, the main control unit 101 compression encodes still image data subjected to image processing by JPEG or the like, or encodes moving image data by a moving image compression method such as MPEG2 or H.264 to create an image file, and records the image file in a recording medium 107. Furthermore, the main control unit 101 performs predetermined calculation processing using captured image data, and the main control unit 101 performs autofocus (AF) processing and auto exposure (AE) processing by controlling the focus lens, the diaphragm, and the shutter of the imaging unit 102 based on the calculation result.

The nonvolatile memory 103 is an electrically erasable and recordable memory, and is an EEPROM or the like. In the nonvolatile memory 103, constants, programs, and the like for operation of the main control unit 101 are recorded. Here, the program is a program for executing control processing described later in the present embodiment.

A working memory 104 is used as a work area in which constants and variables for operation of the main control unit 101, a program read from the nonvolatile memory 103, and the like are developed. In addition, the working memory 104 is used as a buffer memory that temporarily holds image data captured by the imaging unit 102 and an image display memory of the display unit 106.

The operation unit 105 is an operation member such as various switches, buttons, and dials that receive various operations from the user, and notifies the main control unit 101 and a sub control unit 108 of event information generated by the user operating the operation unit 105. The operation unit 105 includes, for example, a power button for turning on or off the power source, a shooting button for instructing start or end of shooting of a still image or shooting of a moving image, a reproduction button for instructing reproduction of an image, and a mode switching button for changing an operation mode of the camera. Furthermore, the operation unit 105 includes a zoom lever or the like that gives a zoom instruction. Moreover, the operation unit 105 includes a touch detection unit 106a integrally configured with a display unit 106 to be described later.

In a still image shooting mode, the main control unit 101 starts the AE control and the AF control by half-pressing the shooting button. In addition, the main control unit 101 executes still image shooting processing of recording image data captured by the imaging unit 102 on the recording medium 107 by fully pressing the shooting button.

Furthermore, in the moving image shooting mode, in response to the initial pressing of the shooting button, the main control unit 101 performs the AE control and the AF control on the image data (frame) captured by the imaging unit 102, and continues moving image shooting processing of recording a moving image of a predetermined time on the recording medium 107. Then, the main control unit 101 stops the moving image shooting processing in response to the shooting button being pressed again.

The display unit 106 displays a live-view image, displays a captured image, displays a graphical user interface (GUI), and the like. The display unit 106 is a display device such as, for example, a liquid crystal display or an organic EL display. The display unit 106 may have a configuration of being integrated with the electronic apparatus 100 or may be an external apparatus connected to the electronic apparatus 100. The electronic apparatus 100 can be connected to the display unit 106 and merely needs to be able to control the display of the display unit 106.

In the recording medium 107, an image file created by the main control unit 101 is recorded, or an image file already recorded in the recording medium 107 is read by the main control unit 101. The recording medium 107 may be a memory card, a hard disk drive, or the like mounted to the electronic apparatus 100, or may be a flash memory or a hard disk drive built in the electronic apparatus 100. The electronic apparatus 100 merely needs to be able to access at least the recording medium 107.

The sub control unit 108 is configured as a microcontroller including a processor such as a CPU, a memory such as a ROM and a RAM, a controller, and a peripheral circuit, and controls a part of the electronic apparatus 100. The sub control unit 108 realizes control processing to be described later by executing a program stored in the ROM. The sub control unit 108 can operate with lower power than the main control unit 101, and is connected to the main control unit 101 so as to be able to transmit and receive data.

A power supplying/charging control unit 109 supplies power received from the power supply apparatus 300 by the first connector 110 or the second connector 120 to each component of the electronic apparatus 100. In addition, the power supplying/charging control unit 109 can charge the battery 111 with power received from the first connector 110 or the second connector 120. Furthermore, the power supplying/charging control unit 109 supplies power from the battery 111 to each component of the electronic apparatus 100.

The first connector 110 and the second connector 120 are interfaces for connection with the power supply apparatus 300, and function as power reception ports that receive power supplied from the power supply apparatus 300. In the present embodiment, the first connector 110 and the second connector 120 are connectors conforming to the USB Type-C standard. The electronic apparatus 100 can communicate with the power supply apparatus 300 via the first connector 110 or the second connector 120 to exchange data. In addition, the electronic apparatus 100 can receive power supplied from the power supply apparatus 300 via the first connector 110 or the second connector 120. Note that in the present embodiment, since the electronic apparatus 100 operates as a USB device, the first connector 110 and the second connector 120 include an interface connector and a USB device controller for performing USB communication with the power supply apparatus 300. The main control unit 101 controls the first connector 110 and the second connector 120 to communicate data based on the USB PD standard and exchange power with the power supply apparatus 300.

The battery 111 supplies power for operating the electronic apparatus 100. The battery 111 is configured to be detachable from the electronic apparatus 100, and can receive and charge power from the first connector 110 or the second connector 120 via the power supplying/charging control unit 109. The battery 111 includes an authentication unit that performs battery authentication processing, and the authentication unit of the battery 111 performs the battery authentication processing with the main control unit 101 or the sub control unit 108 of the electronic apparatus 100.

A power source control unit 112 controls supply and cutoff of power from the battery 111 or the power supplying/charging control unit 109 to each component of the electronic apparatus 100 in accordance with the state of the electronic apparatus 100. The power source control unit 112 is controlled by the main control unit 101 or the sub control unit 108.

A communication switching unit 113 is a bus switch for switching a connection destination of a signal line for data communication between the main control unit 101 and the power supply apparatus 300 to the first connector 110 or the second connector 120.

### Configuration of Power Supply Apparatus 300

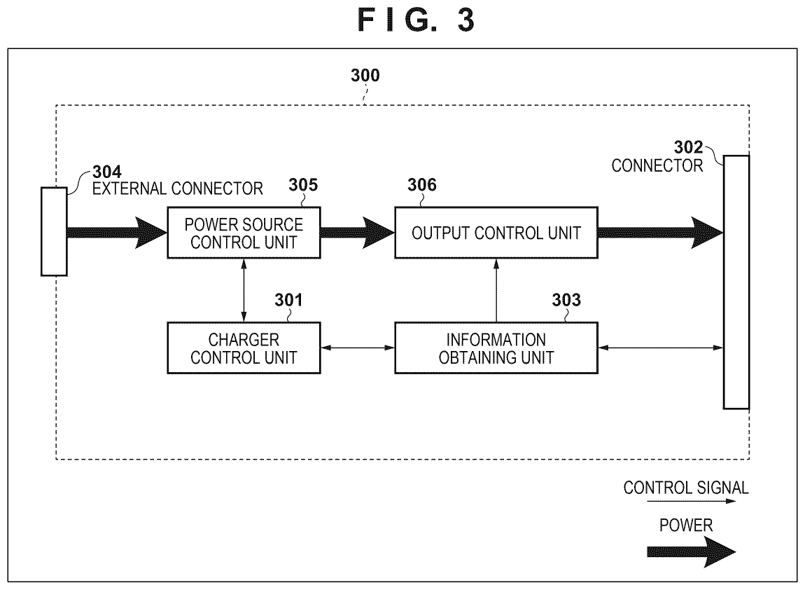

Next, a configuration and a function in a case where the power supply apparatus 300 of the present embodiment is a charger will be described with reference to FIG. 3.

A charger control unit 301 has a microcontroller including a processor such as a CPU, a memory such as a ROM and a RAM, a controller, and a peripheral circuit. The charger control unit 301 controls each component of the power supply apparatus 300 by executing a program stored in the memory. Note that instead of the charger control unit 301 controlling the entire apparatus, the entire apparatus may be controlled by assigning processing to a plurality of pieces of hardware.

A connector 302 is an interface for connection with a power receiving apparatus such as the electronic apparatus 100, and functions as a power supply port that supplies power from the electronic apparatus 100. In the present embodiment, the connector conforms to the USB Type-C standard.

An information obtaining unit 303 is a USB PD controller that performs communication conforming to the USB PD standard with the electronic apparatus 100 via the CC terminal of the first connector 110 or the second connector 120. When the power supply apparatus 300 is connected to the electronic apparatus 100 via the first connector 110 or the second connector 120, the information obtaining unit 303 notifies the power supply capability of the power supply apparatus 300 by the voltage of the CC terminal of the first connector 110. Furthermore, the information obtaining unit 303 communicates with the electronic apparatus 100 via the CC terminal, and performs power negotiation for deciding power (a combination of a voltage value and a current value) to be requested form the power supply apparatus 300.

An external connector 304 is an adapter connected to a commercial power source or the like.

A power source control unit 305 converts the power input from the external connector 304 into power that can be supplied to the electronic apparatus 100. For example, when the external connector 304 supplies power input from a commercial power source (100 V/50 Hz AC power source) to the electronic apparatus 100 (9 V/3 A), the power source control unit 305 converts the AC power source input from the external connector 304 into a DC power source. The charger control unit 301 changes the DC power source converted by the power source control unit 305 to a voltage and a current corresponding to the required power decided by the power negotiation of the information obtaining unit 303, and enables the power source control unit 305 to output such voltage and current. In addition, the charger control unit 301 can change the power that can be output from the power source control unit 305 according to a request received from the power receiving apparatus by the information obtaining unit 303.

An output control unit 306 controls the supply/cutoff of the power output from the power source control unit 305 to the power receiving apparatus via the VBUS terminal based on the timing of the start or stop of the power supply requested by the power receiving apparatus through the communication with the power receiving apparatus by the information obtaining unit 303.

In a case where the power supply apparatus 300 is a power bank, the battery can be charged with power input from the external connector 304 or the connector 302, or the power of the battery can be supplied to the electronic apparatus 100 via the connector 302.

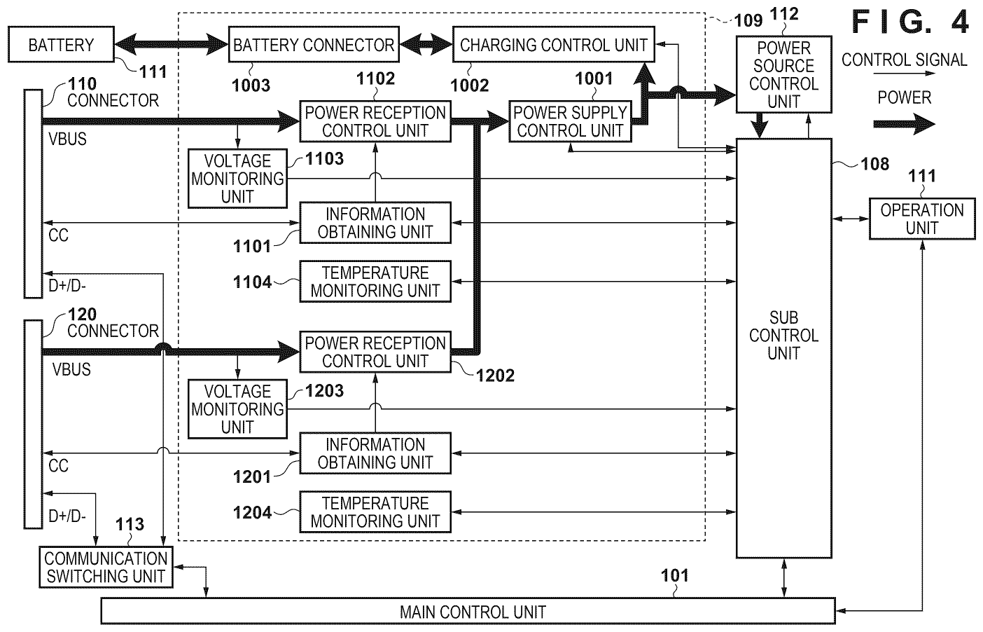

Next, a configuration and a function of the power supplying/charging control unit 109 of the electronic apparatus 100 according to the present embodiment will be described with reference to FIG. 4.

An information obtaining unit 1101 is a USB PD controller that performs communication conforming to the USB PD standard with the power supply apparatus 300 via the CC terminal of the first connector 110. When the power supply apparatus 300 is connected via the first connector 110, the information obtaining unit 1101 detects power (power supply capability) that can be supplied by the power supply apparatus 300 by the voltage of the CC terminal of the first connector 110. Furthermore, the information obtaining unit 1101 communicates with the power supply apparatus 300 via the CC terminal, and performs power negotiation for deciding power (a combination of a voltage value and a current value) to be requested from the power supply apparatus 300. In power negotiation, the information obtaining unit 1101 receives, from the power supply apparatus 300, power supply capability information indicating a voltage and a current that can be supplied by the power supply apparatus 300. Then, the information obtaining unit 1101 transmits the received power supply capability information to the sub control unit 108. The sub control unit 108 decides a voltage to be requested from the power supply apparatus 300 based on the information described in the power supply capability information, and sends the voltage to the information obtaining unit 1101. The information obtaining unit 1101 transmits information indicating the decided voltage to the power supply apparatus 300 to request the decided power to the power supply apparatus. The power supply apparatus 300 outputs the voltage requested by the information obtaining unit 1101 to a power reception control unit 1102 via the VBUS terminal.

The power reception control unit 1102 can receive power supplied from the power supply apparatus 300 connected to the first connector 110 via the VBUS terminal of the first connector 110. The power reception control unit 1102 controls whether or not to supply power to a power supply control unit 1001 according to the information obtained by the information obtaining unit 1101 and the control of the sub control unit 108.

A voltage monitoring unit 1103 monitors the VBUS voltage input from the first connector 110 and notifies the sub control unit 108 of the VBUS voltage. For example, in a case where the power supply capability of the power supply apparatus 300 is 9 V/3 A, the voltage monitoring unit 1103 monitors whether or not the power supply apparatus 300 outputs a voltage (15 V etc.) higher than expected. Alternatively, it is monitored whether the voltage is significantly lower than 9 V due to a short circuit of the electronic apparatus 100 due to an abnormal state or the like. If necessary, the sub control unit 108 instructs the power reception control unit 1102 to stop the power output, and a request is made to the power supply apparatus 300 from the information obtaining unit 1101 to stop the power output.

A temperature monitoring unit 1104 monitors the temperature in the vicinity of the first connector 110 and notifies the sub control unit 108 of the monitored temperature. For example, the temperature monitoring unit 1104 monitors whether the electronic apparatus 100 is in an abnormal state, the first connector 110 is generating heat, and the temperature is higher than or equal to a temperature at which the user can be protected. If necessary, the sub control unit 108 instructs the power reception control unit 1102 to stop the power output, and a request is made to the power supply apparatus 300 from the information obtaining unit 1101 to stop the power output.

An information obtaining unit 1201, A power reception control unit 1202, a voltage monitoring unit 1203, and a temperature monitoring unit 1204 perform data communication and power exchange via the second connector 120, similarly to the information obtaining unit 1101, the power reception control unit 1102, the voltage monitoring unit 1103, and the temperature monitoring unit 1104.

The power supply control unit 1001 converts the VBUS voltage supplied from at least one of the power reception control unit 1102 and the power reception control unit 1202 into a voltage that can be input by the power source control unit 112 and a charging control unit 1002 described later. In the present embodiment, for example, the power supply control unit 1001 steps down the VBUS voltage of 5 V or 9 V to a voltage appropriate for charging the battery. In the present embodiment, the battery 111 includes one cell, and performs constant current charging (CC) or constant voltage charging (CV) so as to be fully charged at 4.2 V. The battery 111 may include two or more cells, or the power supply control unit 1001 may be configured to step up or step down according to the input voltage. In addition, in a case where a battery is not mounted, the power supply control unit 1001 may convert the VBUS voltage supplied from the power reception control unit 1102 into a most efficient voltage for a operation of the electronic apparatus 100 (e.g., 3.7 V) by the power source control unit 112. In addition, the power supply control unit 1001 can control the current to be supplied according to the instruction of the sub control unit 108 based on the power supply capability of the power supply apparatus 300 obtained by the information obtaining unit 1101 and the information obtaining unit 1201. For example, when the power supply capability of the power supply apparatus 300 connected to the first connector 110 is 9 V/3 A, the power supply control unit 1001 steps down the VBUS voltage so that the voltage becomes 4.2 V, which is the rated voltage of the battery 111, and performs control so that a current of greater than or equal to 3.0 A does not flow from the VBUS terminal.

The charging control unit 1002 receives the power input from the VBUS terminal of the first connector 110 from the power supply control unit 1001. The charging control unit 1002 charges the battery 111 connected to a battery connector 1003 described later using power input from the VBUS terminal of the first connector 110. The charging control unit 1002 realizes constant current charging (CC) or constant voltage charging (CV) while controlling the current so as not to affect the battery 111.

The battery connector 1003 can be connected to the battery 111. A power source terminal and a GND terminal, a connection terminal with an authentication circuit of the battery, and a thermistor terminal built in the battery are connected to the battery connector 1003.

### Control Processing

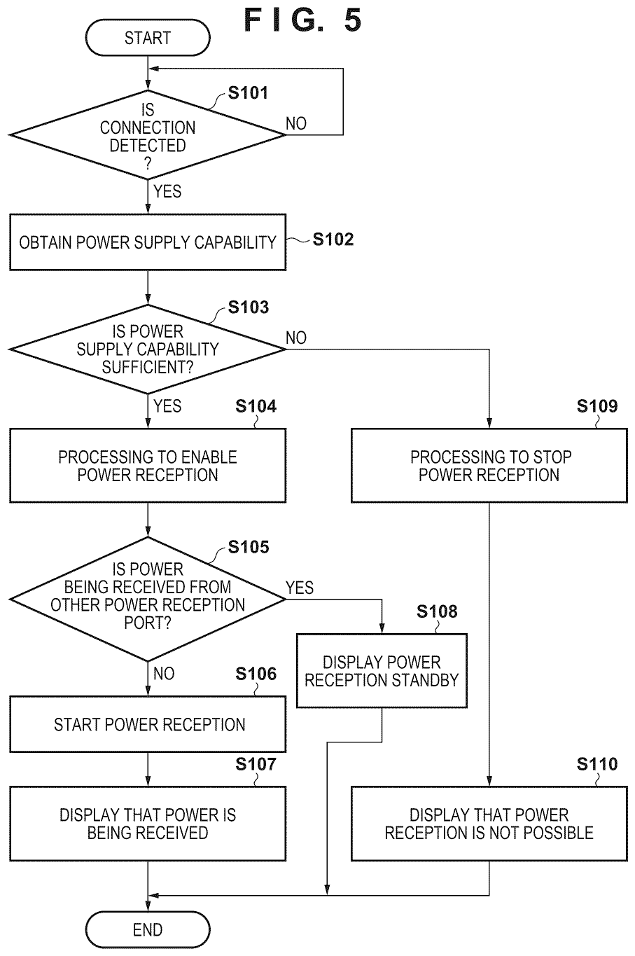

Next, control processing in a case where the power supply apparatus 300 is connected to the electronic apparatus 100 of the present embodiment will be described with reference to FIGS. 5 to 11.

The processing of FIG. 5 illustrates control processing in a case where the power supply apparatus 300 is connected to the first connector 110 of the electronic apparatus 100.

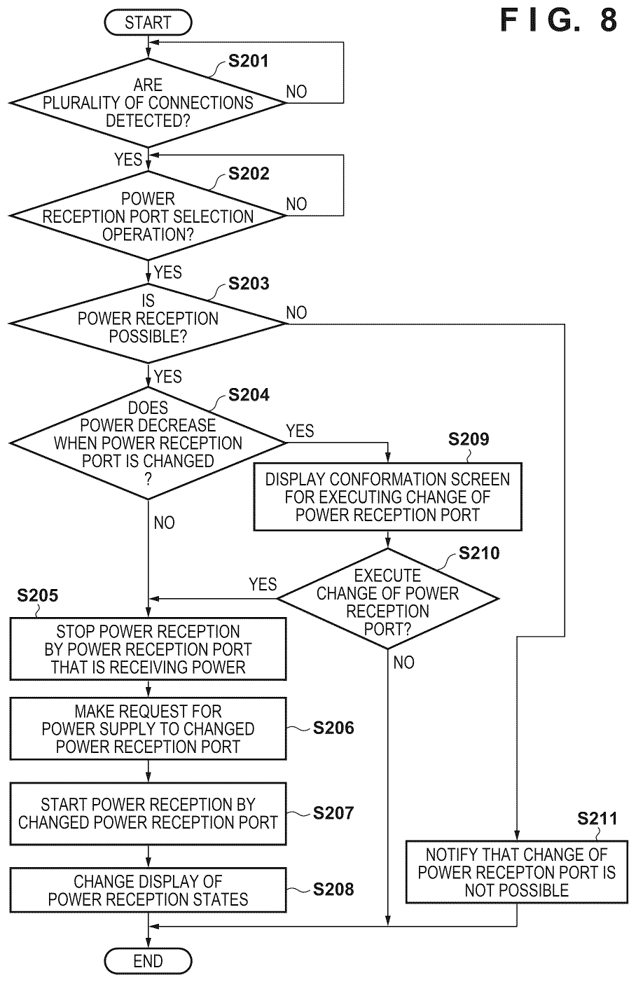

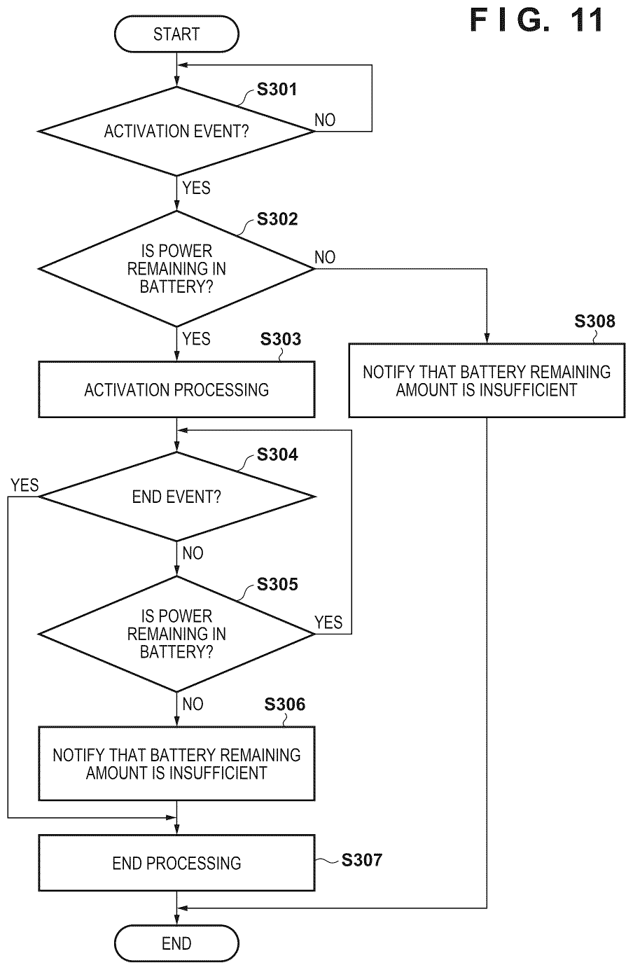

Note that the processing of FIG. 5 is realized by the main control unit 101 of the electronic apparatus 100 loading a program stored in the nonvolatile memory 103 into the working memory 104 and executing the program to control each component of the electronic apparatus 100. The same applies to FIGS. 8 and 11 described later. Furthermore, the processing of FIG. 5 is executed in a state where the electronic apparatus 100 is activated by the power of the battery 111 as described later with reference to FIG. 11.

In the following description, the first connector 110 is referred to as a power reception port 1, and the connector 12 is referred to as a power reception port 2.

In step S101, the main control unit 101 waits until it is detected that the power supply apparatus 300 is connected to the power reception port 1, and when it is detected that the power supply apparatus 300 is connected, proceeds the processing to step S102. The main control unit 101 detects that the power supply apparatus 300 is connected to the power reception port 1 based on the VBUS voltage detected by the voltage monitoring unit 1103 or the voltage level of the CC terminal detected by the information obtaining unit 1101. When the information obtaining unit 1101 detects a change in the power supply capability of the power supply apparatus 300 connected to the power reception port 1, the processing may proceed to step S102.

In step S102, the main control unit 101 obtains the power supply capability of the power supply apparatus 300 connected to the power reception port 1 by the information obtaining unit 1101. In this case, the main control unit 101 may obtain information other than the power supply capability from the power supply apparatus 300 connected to the power reception port 1 by communication via the CC terminal or data communication via the D+/D− terminal.

In step S103, the main control unit 101 determines whether or not the power supply capability of the power supply apparatus 300 connected to the power reception port 1 is sufficient. Here, the main control unit 101 determines whether or not the power supply apparatus 300 connected to the power reception port 1 has the capability to supply power of greater than or equal to a predetermined power based on the information obtained in step S102. Upon determining that the power supply apparatus 300 connected to the power reception port 1 has the capability to supply power of greater than or equal to the predetermined power, the main control unit 101 proceeds the processing to step S104. Upon determining that the power supply apparatus 300 connected to the power reception port 1 does not have the capability to supply power of greater than or equal to the predetermined power, the main control unit 101 proceeds the processing to step S109.

In step S109, the main control unit 101 stops power reception by the power reception port 1. The main control unit 101 stops the input of the VBUS voltage by the power reception control unit 1102, and prevents power from being supplied from the power reception control unit 1102 to the power supply control unit 1001. Alternatively, the main control unit 101 may perform control so as to make a request to the power supply apparatus 300 to reduce the supply power, for example, to request the VBUS current 0 A by communication via the CC terminal by the information obtaining unit 1101.

In step S104, the main control unit 101 enables power reception by the power reception port 1. The main control unit 101 controls the power reception control unit 1102 to prevent the VBUS voltage from being supplied from the power reception control unit 1102 to the power supply control unit 1001. In addition, the main control unit 101 makes a request for necessary power to the power supply apparatus 300 via the CC terminal by the information obtaining unit 1101.

In step S105, the main control unit 101 determines whether or not power is being received by the power reception port 2 different from the power reception port 1. The main control unit 101 proceeds the processing to step S108 upon determining that the power reception port 2 is receiving power, and proceeds the processing to step S106 upon determining that the power reception port 2 is not receiving power.

In step S106, the main control unit 101 controls the power reception control unit 1102 to start output the VBUS voltage to the power supply control unit 1001 and starts power reception by the power reception port 1. At this time, power requested from the power supply apparatus 300 in step S104 is supplied from the power supply apparatus 300.

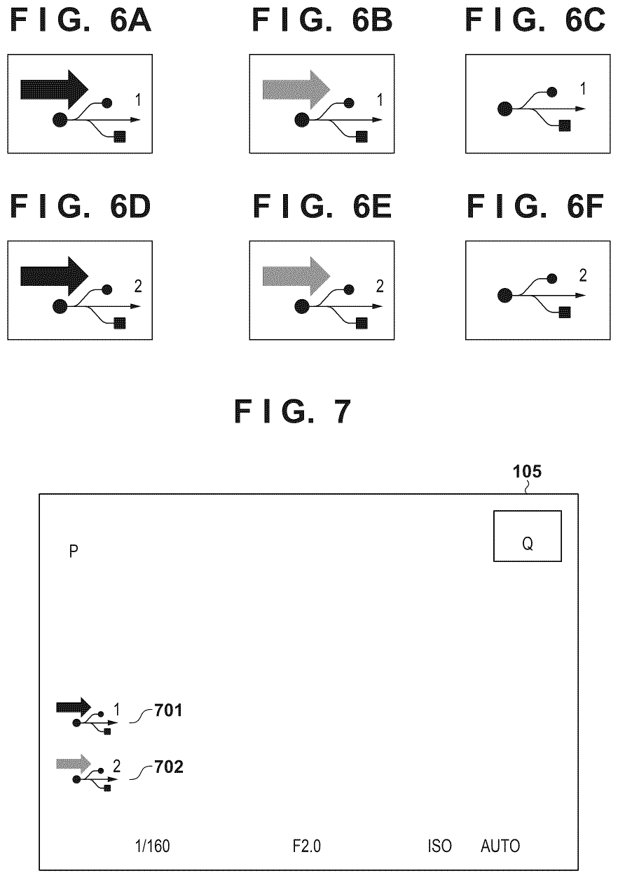

The main control unit 101 displays icons indicating the respective power reception ports on the display unit 106. Specifically, a first icon indicating the first power reception port and a second icon indicating the second power reception port are displayed on the display unit 106. Then, the control unit 101 displays the icon in a first display mode when power is being received from the power supply apparatus connected to the power reception port. In addition, when power is not being received from the power supply apparatus connected to the power reception port but can be received, the control unit 101 displays the icon in a second display mode. Furthermore, when power reception from the power reception port is not possible (power reception is not possible), the control unit 101 displays the icon in a third display mode. Therefore, in step S107, as the determination result in step S105, the main control unit 101 displays, on the display unit 106, an icon in the first display mode indicating that power is being received by the power reception port 1 as illustrated in FIG. 6A.

In step S108, as a result of the determination in step S105, the main control unit 101 displays, on the display unit 106, an icon indicating that power reception is possible (power reception standby) although power reception from the power reception port 1 is not being performed as illustrated in FIG. 6B.

In step S110, as a result of the determination in step S103, the main control unit 101 displays, on the display unit 106, an icon indicating that power reception by the power reception port 1 is not possible as illustrated in FIG. 6C.

Note that when the connection between the power supply apparatus 300 and the power reception port 1 is disconnected after the connection of the power supply apparatus 300 is detected in step S101 of FIG. 5, the processing returns to step S101 to detect the connection of the power supply apparatus 300.

Although the processing in a case where the power supply apparatus 300 is connected to the power reception port 1 has been described above, similarly in a case where the power supply apparatus 300 is connected to the power reception port 2, the power reception control of the power reception control unit 1202 and the display control of the icons of FIGS. 6D to 6F showing the power reception state by the power reception port 2 are performed.

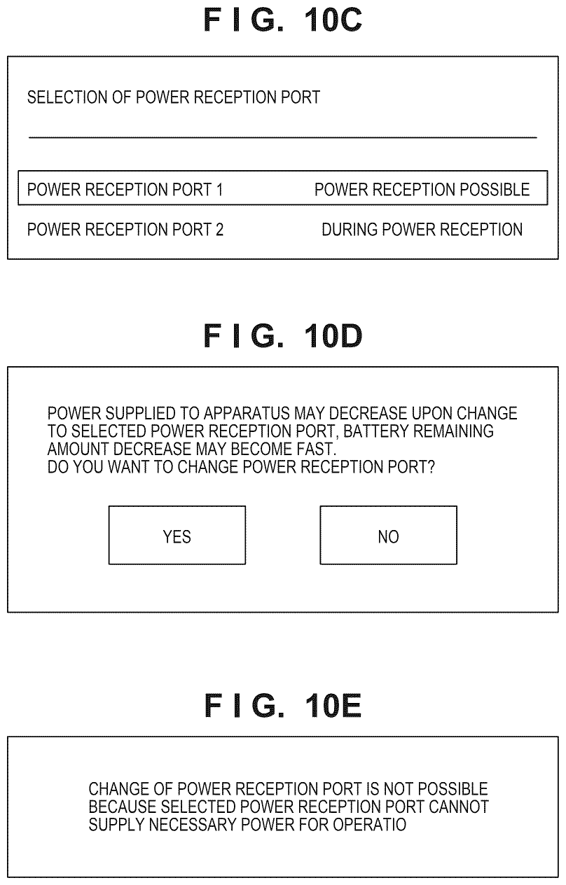

FIG. 7 illustrates a state in which the icons indicating the power reception state of FIGS. 6A and 6E are displayed on the screen displayed on the display unit 106 of the electronic apparatus 100. In the example of FIG. 7, the power supply apparatus 300 is connected to the power reception port 1 and the power reception port 2, and the icon 701 of FIG. 6A indicating that the power reception port 1 is receiving power and the icon 702 of FIG. 6E indicating that the power reception port 2 is in standby to receive power are displayed. Note that the icon indicating the power reception state may not be always displayed, and for example, the icon may be hidden when a certain period of time has elapsed in a non-operation state. Alternatively, as in the screens of FIGS. 10A to 10C to be described later, it may be displayed that the power reception port 1 is receiving power in step S107 of FIG. 5, the power reception port 1 is in standby to receive power in step S108, and the power reception port 1 cannot receive power in step S109.

Next, changing processing of the power reception port of the electronic apparatus 100 according to the present embodiment will be described with reference to FIG. 8.

The processing of FIG. 8 illustrates a control processing in a case where the power supply apparatus 300 is connected to the power reception port 1 and the power reception port 2, and a user operation for instructing a change to power reception by the power reception port 2 is received in a state where the power reception port 1 is receiving power and the power reception port 2 is not receiving power.

In step S201, the main control unit 101 waits until it is detected that the power supply apparatus 300 is connected to the power reception port 1 and the power reception port 2, and when it is detected that the power supply apparatus 300 is connected to the power reception port 1 and the power reception port 2, proceeds the processing to step S202.

In step S202, the main control unit 101 waits until an instruction from the user to select the power reception port by the operation unit 105 is detected. When the operation by the user to select the power reception port is detected, the main control unit 101 proceeds the processing to step S203. As the operation for selecting the power reception port, for example, there is a method of touching for a predetermined time or longer, the icons or surrounding areas of the icons in FIGS. 6B and 6E indicating power reception standby displayed on the screen in FIG. 7. Alternatively, there is a method of selecting by operating the operation unit 105 or selecting by a touch operation, a selection frame of the power reception port that can receive power on the screen of FIG. 10.

FIGS. 10A to 10C illustrate a power reception port selection screen displayed on the display unit 106 of the electronic apparatus 100 when the power supply apparatus 300 is connected to the power reception port 1 and the power reception port 2. A menu screen is displayed on the display unit 106 of the electronic apparatus 100 by the user operation of the operation unit 105. The user selects a function for selecting the power reception port using the menu screen and the port selection screen is displayed on the display unit 106. The user can instruct the change to the selected power reception port by selecting the selection frame of the power reception port that can receive power on the screen of FIG. 10A or FIG. 10C.

In step S203, the main control unit 101 determines whether or not power reception by the power reception port selected by the power reception port selecting operation in step S202 is possible. Upon determining that power reception by the power reception port selected in step S202 is possible, the main control unit 101 proceeds the processing to step S204. Upon determining that power reception by the power reception port selected in step S202 is not possible, the main control unit 101 proceeds the processing to step S211.

For example, in a case where the icon of FIG. 6B or FIG. 6E showing power reception standby is displayed on the screen of FIG. 7, when the touch detection unit 106a detects that the icon or the surrounding area of the icon has been touched for a predetermined time or longer, the main control unit 101 determines that the power reception by the selected power reception port is possible. Alternatively, in the screen of FIG. 10A or FIG. 10C, when the selection frame of the power reception port that can receive power is selected, the main control unit 101 determines that power reception by the selected power reception port is possible.

In addition, for example, in a case where the icon of FIG. 6C or FIG. 6F showing that the power reception is not possible is displayed on the screen of FIG. 7, when the touch detection unit 106a detects that the icon or the surrounding area of the icon has been touched for a predetermined time or longer, the main control unit 101 determines that the power reception by the selected power reception port is not possible. Alternatively, in the screen of FIG. 10B, when the selection frame of the power reception port that cannot receive power is selected, the main control unit 101 determines that power reception by the selected power reception port is not possible.

In step S211, the main control unit 101 notifies the user that the change to the power reception port selected in step S202 cannot be made, and ends the processing. In step S211, for example, the screen of FIG. 10E is displayed on the display unit 106. In the example of FIG. 10E, by notifying that the change cannot be made as the selected power reception port cannot supply sufficient power to the electronic apparatus 100, the user can recognize that the change cannot be made to the selected power reception port.

In step S204, the main control unit 101 compares (i) the power that can be supplied by the power supply apparatus 300 from which power is being received with (ii) the power that can be supplied by the power supply apparatus 300 connected to the power reception port selected in step S202. Then, the main control unit 101 determines whether or not the power supplied from the power supply apparatus 300 decreases after changing the power reception port rather than before changing the power reception port. When the main control unit 101 determines that the power that can be supplied by the power supply apparatus 300 connected to the power reception port selected in step S202 is larger than or equal to the power that can be supplied by the power supply apparatus 300 from which power is being received, the main control unit 101 proceeds the processing to step S205. Upon determining that the power that can be supplied by the power supply apparatus 300 connected to the power reception port selected in step S202 is smaller than the power that can be supplied by the power supply apparatus 300 from which power is being received, the main control unit 101 proceeds the processing to step S209.

In step S209, the main control unit 101 notifies the user that the power supplied to the electronic apparatus 100 decreases when the power reception port is changed to the selected power reception port. Then, the main control unit 101 displays, on the display unit 106, a screen for allowing the user to select whether or not to execute the change of the power reception port. Here, for example, the screen of FIG. 10D is displayed. In this embodiment, when the power from the power supply apparatus 300 connected to the power reception port is insufficient for the operation of the electronic apparatus 100, the power is also supplied from the battery 111. In the example of FIG. 10D, notification is made that when the power reception port is changed to the power reception port selected in step S202, the power supplied to the electronic apparatus 100 decreases, the power supplied from the battery 111 increases, and there is a possibility that the decrease in the remaining amount of the battery 111 will accelerate, so that the user can reconsider whether or not to change the power reception port to the selected power reception port.

In step S210, the main control unit 101 determines whether or not the operation unit 105 has been operated by the user and an instruction to change the power reception port has been received. Upon determining that the instruction to change the power reception port has been received, the main control unit 101 proceeds the processing to step S205. Upon determining that the operation unit 105 is operated by the user and an instruction not to change the power reception port is received, the main control unit 101 ends the processing. For example, when the user operates “Yes” on the screen of FIG. 10D, the main control unit 101 determines that the instruction to change the power reception port has been received, and when the user operates “No”, the main control unit determines that the instruction not to change the power reception port has been received.

In steps S205 to S207, the main control unit 101 executes the processing of changing the power reception port.

In step S205, the main control unit 101 stops power reception by the power reception port that is receiving power. The main control unit 101 stops the output of the VBUS voltage from the power reception control unit 1102 to the power supply control unit 1001. In this case, since the power supply of all the power reception ports is temporarily stopped, the electronic apparatus 100 operates by the power of the battery 111. Note that the VBUS voltage from the power supply apparatus 300 connected to the power receiving port 1 may be changed from the requested voltage to 5V by sending the request to change the requested voltage of 5V after the power reception from the power reception port 1 is stopped.

In step S206, the main control unit 101 makes a request for necessary power to the power supply apparatus 300 connected to the power reception port 2 after the change via the CC terminal by the information obtaining unit 1201. In addition, the main control unit 101 changes the setting of the voltage limit value and the current limit value of the power supply control unit 1001 by the sub control unit 108. In this case, as described above, the information obtaining unit 1201 performs a power negotiation processing with the power supply apparatus 300 connected to the power reception port 2, and the sub control unit 108 decides a voltage to be requested from the power supply apparatus 300. Then, the information obtaining unit 1201 makes a request to the power supply apparatus 300 connected to the power reception port 2 for the decided voltage.

In step S207, the power reception control unit 1202 receives the requested power from the power supply apparatus 300 connected to the power reception port 2. The main control unit 101 starts the output of the VBUS voltage received by the power reception control unit 1202 to the power supply control unit 1001, and starts power reception from the power supply apparatus 300 connected to the power reception port 2 after the change.

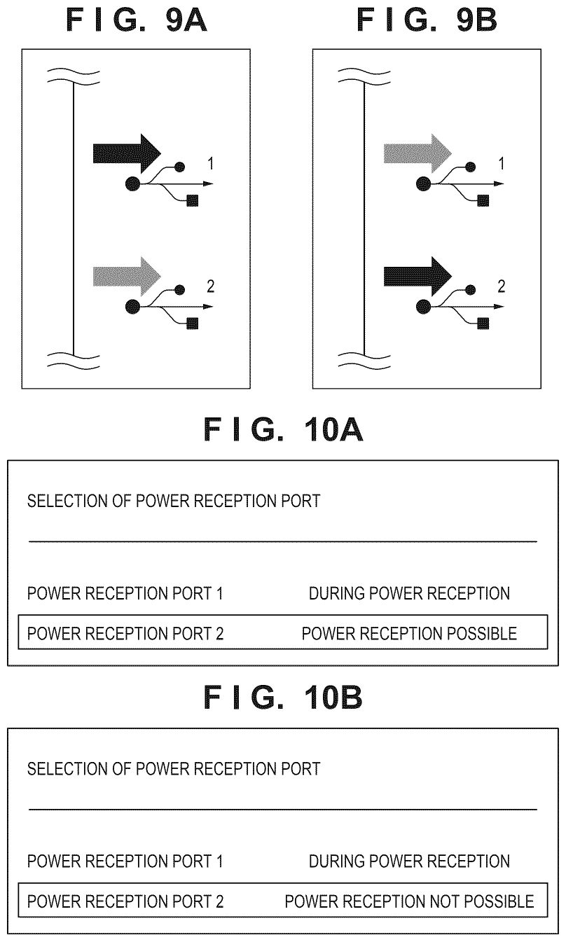

In step S208, the main control unit 101 displays icons corresponding to the power reception states of the power reception port 1 and the power reception port 2 on the display unit 106. For example, the main control unit 101 switches the icons 701 and 702 displayed on the screen of FIG. 7 from the icon indicating that the power reception port 1 is receiving power and the icon indicating that the power reception port 2 is waiting for power reception illustrated in FIG. 9A to the icon indicating that the power reception port 1 is waiting for power reception and the icon indicating that the power reception port 2 is receiving power illustrated in FIG. 9B. Alternatively, the main control unit 101 switches the screen of FIG. 10A displayed on the display unit 106 to the screen of FIG. 10C.

When the connection of the power supply apparatus 300 to the power reception port 1 or the power reception port 2 is disconnected during the processing of FIG. 8, the processing returns to step S201 to detect the connection of the power supply apparatus 300.

As described above, when the processing from step S205 to step S207 is executed, the power supply to all the power reception ports is temporarily stopped, and thus the electronic apparatus 100 needs to operate by the power of the battery 111. Therefore, when the processing of FIG. 8 is executed, the power for operating the electronic apparatus 100, for example, power for activating the electronic apparatus 100 from the sleep state needs to be left in the battery 111.

FIG. 11 is a flowchart illustrating control processing according to the remaining amount (capacity) of the battery 111 by the electronic apparatus 100 of the present embodiment. Note that the processing of FIG. 11 is executed by the main control unit 101 of the electronic apparatus 100 in the sleep state. The processing of FIG. 8 is executed in a state where the electronic apparatus 100 is activated in the processing of FIG. 11.

In step S301, the main control unit 101 waits until an activation event occurs by the operation of the operation unit 105 or the like, and when the activation event occurs, proceeds the processing to step S302.

In step S302, the main control unit 101 determines whether or not power for operating the electronic apparatus 100, for example, power for activating the electronic apparatus 100 from the sleep state is remaining in the battery 111. In a case where the main control unit 101 determines that power for operating the electronic apparatus 100 is remaining in the battery 111, the main control unit proceeds the processing to step S303. In a case where the main control unit 101 determines that power for operating the electronic apparatus 100 is not remaining in the battery 111, the main control unit proceeds the processing to step S308. In the determination method, for example, determination can be made that power for activating the electronic apparatus 100 from the sleep state is remaining in the battery 111 when the voltage of the battery 111 is greater than or equal to a predetermined threshold. Alternatively, in a case where the battery 111 includes a fuel gauge, remaining amount information of the fuel gauge can be obtained from the battery 111, and determination can be made that power for activating the electronic apparatus 100 from the sleep state is remaining in the battery 111 when the remaining amount of the battery 111 is greater than or equal to a predetermined threshold.

In step S308, the main control unit 101 notifies the user, by displaying on the display unit 106 for a certain period of time, that activation cannot be performed due to an insufficient remaining amount of the battery 111 and that the battery 111 needs to be charged for activation, and ends the processing. Note that the processing of step S308 may not be executed.

In step S303, the main control unit 101 performs activation processing of the electronic apparatus 100. The main control unit 101 supplies the power of the battery 111 to each component of the electronic apparatus 100 by the power supplying/charging control unit 109, so that the electronic apparatus 100 becomes operable state in each operation mode.

The processing of steps S304 and S305 are periodically executed.

In step S304, the main control unit 101 determines whether or not an end event has occurred by the operation of the operation unit 105 or the like, and proceeds the processing to step S307 when the end event has occurred, and proceeds the processing to step S305 when the end event has not occurred.

In step S305, the main control unit 101 determines whether or not power for operating the electronic apparatus 100 is remaining in the battery 111. When the main control unit 101 determines that the power for operating the electronic apparatus 100 is remaining in the battery 111, the main control unit returns the processing to step S304. In a case where the main control unit 101 determines that power for operating the electronic apparatus 100 is not remaining in the battery 111, the main control unit proceeds the processing to step S306. The method for determining the remaining amount of the battery is similar to that in step S302.

In step S306, the main control unit 101 notifies the user, by displaying on the display unit 106 for a certain period of time, that the activation is to be ended due to an insufficient remaining amount of the battery 111 and that the battery 111 needs to be charged for activation, and ends the processing. Note that the processing of step S306 may not be executed.

In step S307, the main control unit 101 performs end processing of the electronic apparatus 100, and ends the processing.

Before the execution of step S307, the user may be notified that there is no remaining amount of the battery 111 by the display unit 106 or the like in step S306. The main control unit 101 stops power supply to each component of the electronic apparatus 100 by the power supplying/charging control unit 109 and shifts to the sleep state.

With the above-described processing, a state in which the battery 111 always has power for operating the electronic apparatus 100 can be maintained during the activation of the electronic apparatus 100.

Note that it is also assumed that the electronic apparatus 100 of the present embodiment is in a state in which power necessary for the operation of the electronic apparatus 100 is received from the power supply apparatus 300 connected to the power reception port although the remaining amount of the battery 111 is insufficient or the battery 111 is not mounted. In this case, the order of the processing in steps S205 and S207 in FIG. 8 may be reversed so that power reception from the power reception port is always continued and the power reception port can be changed even if the remaining amount of the battery 111 is insufficient. In a case where the order of the processing in steps S205 and S207 is reversed, there is a possibility that a countermeasure such as equipping a backflow prevention function on the power reception control unit 1102 and the power reception control unit 1202 is required.

In the above-described embodiment, an example has been described in which the electronic apparatus 100 has two power reception ports of the first connector 110 and the second connector 120, but the electronic apparatus may have three or more power reception ports. In this case, the user selects a power reception port that is not receiving power in a state of receiving power from one of the plurality of power reception ports and not receiving power from other power reception ports. Then, according to the selection instruction of the user, control is performed such that power reception from the power reception port receiving power is stopped and power reception from the selected power reception port is started.

According to the present embodiment, it is possible to, during the power reception from the power supply apparatus connected to any of the plurality of power reception ports, change the power reception to the power reception from the power supply apparatus connected to another power reception port in response to receiving the operation instructing to change the power reception port from the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-209546, filed Dec. 12, 2023 which is hereby incorporated by reference herein in its entirety.

What is claimed is:

1. An electronic apparatus comprising:
a first power reception port;
a second power reception port; and
at least one processor that causes the electronic apparatus to function as:
a communication unit that, when a first power supply apparatus is connected to the first power reception port, communicates with the first power supply apparatus, and when a second power supply apparatus is connected to the second power reception port, communicates with the second power supply apparatus;
a power reception unit that receives power supplied from the first power supply apparatus via the first power reception port and receives power supplied from the second power supply apparatus via the second power reception port; and
a control unit that performs control to, when the power reception unit receives power from the first power supply apparatus connected to the first power reception port and does not receive power from the second power supply apparatus connected to the second power reception port, stop power reception from the first power supply apparatus connected to the first power reception port and start power reception from the second power supply apparatus connected to the second power reception port in response to receiving an instruction from a user to select the second power reception port.

2. The apparatus according to claim 1, wherein
when power suppliable by the second power supply apparatus connected to the second power reception port is smaller than a predetermined power, the control unit performs control not to stop power reception from the first power supply apparatus and not to start power reception from the second power supply apparatus according to the instruction.

3. The apparatus according to claim 2, wherein
when power suppliable by the second power supply apparatus connected to the second power reception port is smaller than the predetermined power, the control unit notifies a user that change of a power reception port cannot be made.

4. The apparatus according to claim 1, wherein
when power suppliable by the second power supply apparatus connected to the second power reception port is smaller than power suppliable by the first power supply apparatus connected to the first power reception port, the control unit makes a notification for inquiring a user whether or not to change to the second power reception port in response to the instruction, and stops the power reception from the first power supply apparatus connected to the first power reception port and starts the power reception from the second power supply apparatus connected to the second power reception port in response to receiving an instruction to change from the user.

5. The apparatus according to claim 1, wherein
the control unit displays a first icon indicating the first power reception port and a second icon indicating the second power reception port, and performs control to display each of the first icon and the second icon by any display mode including a first display mode indicating that power is being received from a power supply apparatus connected to the first power reception port or the second power reception port, a second display mode indicating that power is receivable although power is not being received from the power supply apparatus connected to the first power reception port or the second power reception port, and a third display mode indicating that power cannot be received via the first power reception port or the second power reception port.

6. The apparatus according to claim 5, wherein the at least one processor further causes the electronic apparatus to function as:
a detection unit that detects a touch operation on the first icon or the second icon; wherein
the control unit determines that the instruction has been received when the detection unit detects a touch operation on the second icon displayed in the second display mode.

7. The apparatus according to claim 5, wherein
the control unit determines whether or not power can be received from the first power supply apparatus connected to the first power reception port based on information about power supply capability of the first power supply apparatus received by the communication unit from the first power supply apparatus and displays the first icon in the third display mode when power cannot be received from the first power supply apparatus, and determines whether or not power can be received from the second power supply apparatus connected to the second power reception port based on information about power supply capability of the second power supply apparatus received by the communication unit from the second power supply apparatus and displays the second icon in the third display mode when power cannot be received from the second power supply apparatus.

8. The apparatus according to claim 5, wherein
the control unit determines whether or not power can be received from the first power supply apparatus connected to the first power reception port based on information about power supply capability of the first power supply apparatus received by the communication unit from the first power supply apparatus and displays the first icon in the second display mode when power can be received from the first power supply apparatus but power is not being received from the first power supply apparatus, and determines whether or not power can be received from the second power supply apparatus connected to the second power reception port based on information about power supply capability of the second power supply apparatus received by the communication unit from the first power supply apparatus and displays the second icon in the second display mode when power can be received from the second power supply apparatus but power is not being received from the second power supply apparatus.

9. The apparatus according to claim 1, wherein
the control unit decides power to be requested from the first power supply apparatus according to a communication with the first power supply apparatus by the communication unit, requests a power supply from the first power supply apparatus via the communication unit, decides power to be requested from the second power supply apparatus according to a communication with the second power supply apparatus by the communication unit, and requests a power supply from the second power supply apparatus via the communication unit.

10. The apparatus according to claim 1, wherein
the electronic apparatus can operate using power from a battery connected to the electronic apparatus.

11. The apparatus according to claim 10, wherein the at least one processor further causes the electronic apparatus to function as:
a charging unit that charges the battery with the power received by the power reception unit.

12. The apparatus according to claim 1, wherein
the first power reception port and the second power reception port respectively includes interface conforming to a USB Type-C standard, and
the electronic apparatus is an apparatus conforming to a universal serial bus (USB) power delivery (PD) standard.

13. A control method of an electronic apparatus: wherein
the electronic apparatus includes,
a first power reception port,
a second power reception port,
a communication unit that, when a first power supply apparatus is connected to the first power reception port, communicates with the first power supply apparatus, and when a second power supply apparatus is connected to the second power reception port, communicates with the second power supply apparatus, and
a power reception unit that receives power supplied from the first power supply apparatus via the first power reception port and receives power supplied from the second power supply apparatus via the second power reception port; and
the control method includes:
performing control to, when the power reception unit receives power from the first power supply apparatus connected to the first power reception port and does not receive power from the second power supply apparatus connected to the second power reception port, stop power reception from the first power supply apparatus connected to the first power reception port and start power reception from the second power supply apparatus connected to the second power reception port in response to receiving an instruction from a user to select the second power reception port.

14. A no-transitory computer-readable storage medium storing a program for causing a computer to execute a control method of an electronic apparatus comprising:
a first power reception port;
a second power reception port;
a communication unit that, when a first power supply apparatus is connected to the first power reception port, communicates with the first power supply apparatus, and when a second power supply apparatus is connected to the second power reception port, communicates with the second power supply apparatus;
a power reception unit that receives power supplied from the first power supply apparatus via the first power reception port and receives power supplied from the second power supply apparatus via the second power reception port; and
the control method includes:
performing control to, when the power reception unit receives power from the first power supply apparatus connected to the first power reception port and does not receive power from the second power supply apparatus connected to the second power reception port, stop power reception from the first power supply apparatus connected to the first power reception port and start power reception from the second power supply apparatus connected to the second power reception port in response to receiving an instruction from a user to select the second power reception port.
